(19) United States
(12) Patent Application Publication
(10) Pub. No.: US 2007/0065661 A1
(43) Pub. Date: Mar. 22, 2007

(54) Tape-lets

(76) Inventor: Sarah Marie Martinez, Fort Worth, TX (US)

Correspondence Address: Sarah Martinez, 5116 Tulane, Fort Worth, TX, 76114, US

(21) Appl. No.: 11/128,536

(22) Filed: Sep. 19, 2005

(51) Int. Cl. B32B 7/12

(52) U.S. Cl. 428/354; 428/343

(57) ABSTRACT

A Tape-Let is oval shaped to fit on the end of a finger. A Tape Let is double sided tape with a non stick tab on one end. The tape-let is to be placed on the pointer finger or the middle finger, which ever the user prefers. They are used to aid in counting, sorting papers, or flipping through pages. The stickiness of the tape-let will pick up the page while stuck to one's finger, so you can turn the page with ease. It keeps you from having to lick you finger to turn the page. The Tape-Let makes life a little easier for your every day secretary!

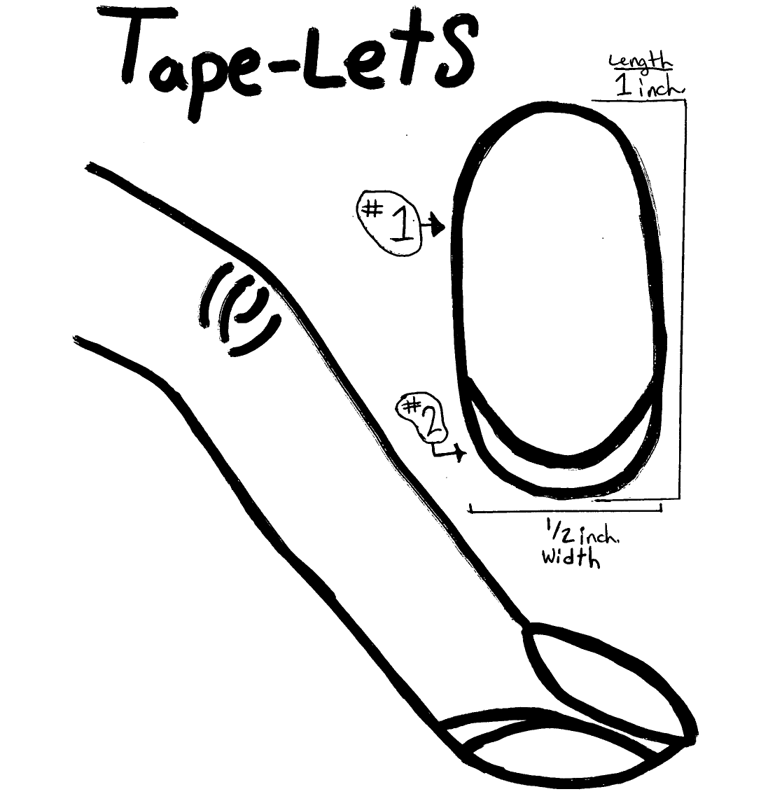

Making:

A double-sided single-liner pressure-sensitive adhesive strip of tape, that has a pressure-sensitive adhesive on both sides of the single-liner. It is cut in an oval shape to fit and grip a finger properly. The oval shaped tape is a double-sided non adhesive release tab, on only one end. The tab is for the double-sided oval shaped tape for easy removal.

Directions on How to Use:

Once the tape-lets are made than proceed to place it on your finger with the non adhesive tab facing the palm of your hand. Then lightly push the pressure adhesive tape so that it is secure on your finger. Than just as you would turn a pages, place your finger (with the Tap-let) on the corner of the page and proceed to turn the pages, to count or flip through with ease. To release tape-lets from the page roll finger. The tape should still be stuck to your finger and the page should be turned. Once you are finished turning pages pull the non stick tab, to remove the tape-let from your finger and dispose.

I claim:

1. An oval shaped double sided adhesive piece of single-liner tape with a non stick tab on one end of the oval.
a) A double sided tape that one side sticks to your finger, the opposite side of the tape will stick to paper and will pick up the page and release the page without tearing the paper.
b) An alternative way to flipping paper pages. A Quicker and more sanitary way of turning pages.
c) A non stick tab for removing the tap from your finger when job is complete.
d) I claim Tape-lets
